(19) United States
(12) Patent Application Publication
(10) Pub. No.: US 2012/0144206 A1
(43) Pub. Date: Jun. 7, 2012

(54) INFORMATION PROCESSING APPARATUS, REMOVABLE STORAGE DEVICE, INFORMATION PROCESSING METHOD, AND INFORMATION PROCESSING SYSTEM

(75) Inventor: Munetake Ebihara, Kanagawa (JP)

(73) Assignee: SONY CORPORATION, Tokyo (JP)

(21) Appl. No.: 13/298,415

(22) Filed: Nov. 17, 2011

(30) Foreign Application Priority Data
Dec. 1, 2010 (JP) 2010-268607

(51) Int. Cl. G06F 12/14

(52) U.S. Cl. 713/189

(57) ABSTRACT

An information processing apparatus includes an encrypted authentication unit that obtains, as encrypted information, the estimated total capacity of a storage medium included in a removable storage device, which is the target of encrypted authentication, a storage use unit that obtains the total capacity of a storage medium to which data is written, and a determination unit that restricts the use by the storage use unit of the storage medium to which the data is written depending on whether the difference between the estimated total capacity and the total capacity is equal to or more than a predetermined threshold.

### BACKGROUND

The present disclosure relates to an information processing apparatus, removable storage device, information processing method, and information processing system.

With the progress of information processing technology, digital data continues to increase. Of storage media that store digital data, removal storage devices are widely used because they are useful for carrying digital data.

As proposed in, for example, Japanese Unexamined Patent Application Publication No. 2006-085479, some of these removal storage devices achieve the following functions etc. by using encrypted authentication with the host device to which they are connected.

Function of providing an encrypted communication path for achieving the session property, integrity, and concealment

Function of reading a product-specific identifier while ensuring the session property and integrity

Function of reading and writing accounting information and copy protection use conditions while ensuring the session property and integrity

Function of reading and writing secret information and copy protection contents while ensuring the concealment

### SUMMARY

The host device can use the above encrypted authentication to confirm that the authentic storage media product is connected. However, determination is not made as to whether the storage medium on which data is actually read or written is the storage medium incorporated in the above authentic storage media product. Accordingly, the storage capacity of storage medium on which the host device actually reads or writes data may be different from the storage capacity of the storage medium incorporated in the storage media product authenticated.

It is desirable to provide a novel and improved information processing apparatus, removable storage device, information processing method, and information processing system that can compare the storage capacity of a storage medium on which data is read or written with the storage capacity of the storage medium incorporated in the storage media product to be authenticated in encrypted authentication between the host device and the storage media product, and restrict the use of the storage medium on which data is read or written on the basis of the result of the comparison.

According to an embodiment of the present disclosure, there is a provided an information processing apparatus including an encrypted authentication unit that obtains, as encrypted information, an estimated total capacity of a storage medium included in a removable storage device, the removable storage device being a target of encrypted authentication, a storage use unit that obtains a total capacity of a storage medium to which data is written, and a determination unit that restricts the use by the storage use unit of the storage medium to which the data is written depending on whether a difference between the estimated total capacity and the total capacity is equal to or more than a predetermined threshold.

In this structure, it is possible to determine whether to restrict the use by the storage use unit of the storage medium to which the data is written on the basis of the difference between the total capacity of the storage medium of the removal storage device, which is the target of encrypted authentication, and the total capacity of the storage medium to which data is written. Accordingly, when, for example, an apparatus other than storage devices that has been subjected to encrypted authentication processing is connected to the information processing apparatus and a storage medium to which data is written is not the storage medium incorporated in the storage device that has been subjected to encrypted authentication processing, the use of the storage medium can be restricted.

When the determination unit determines that the difference is equal to or more than the predetermined threshold, the storage use unit may operate using the estimated total capacity or the total capacity, whichever is smaller, as the capacity of the storage medium.

When the determination unit determines that the difference is equal to or more than the predetermined threshold, the storage use unit may not read or write data on the storage device.

According to an embodiment of the present disclosure, there is provided a removal storage device including a storage unit that stores data and an encrypted authentication unit that performs encrypted authentication with an information processing apparatus connected through an encrypted communication path and encrypts an estimated total capacity of the storage unit to provide the encrypted estimated total capacity for the information processing apparatus.

According to an embodiment of the present disclosure, there is provided an information processing method including performing encrypted authentication with a removal storage device connected through an encrypted communication path, obtaining an estimated total capacity of a storage area of the removal storage device as encrypted information, obtaining a total capacity of an external storage medium to which data is written, determining whether a difference between the estimated total capacity and the total capacity is equal to or more than a predetermined threshold, and restricting the reading and writing of data for the storage medium depending on whether the difference between the estimated total capacity and the total capacity is equal to or more than the predetermined threshold.

According to an embodiment of the present disclosure, there is provided an information processing system having a removal storage device including a storage unit that stores data and a first encrypted authentication unit that encrypts and provides an estimated total capacity of the storage unit, and an information processing apparatus having a second encrypted authentication unit that obtains the estimated total capacity, a storage use unit that obtains a total capacity of the storage unit, and a determination unit that restricts the use by the storage use unit of the storage unit depending on whether a difference between the estimated total capacity and the total capacity is equal to or more than a predetermined threshold.

As described above, according to the embodiments of the present disclosure, there is provided an information processing apparatus, a removal storage device, an information processing method, and an information processing system that compare the storage capacity of storage medium on which data is read or written with the storage capacity of the storage medium incorporated in the storage media product to be authenticated, and restrict the use of the storage medium on which data is read or written on the basis of the result of the comparison.

### BRIEF DESCRIPTION OF THE DRAWINGS

FIG. 1 is a functional block diagram showing a storage use system according to an embodiment of the present disclosure.

FIG. 2 shows the hardware structure of an information processing apparatus according to the embodiment.

FIG. 3 is a sequence diagram showing a first operation example of a storage use system according to the embodiment.

FIG. 4 is a sequence diagram showing a second operation example of the storage use system according to the embodiment.

FIG. 5 describes effects given by the structure of the storage use system according to the embodiment.

### DETAILED DESCRIPTION OF EMBODIMENTS

A preferred embodiment will be described with reference to the drawings. In the specification and drawings, elements with substantially the same function may be denoted by the same reference numerals, and repeated descriptions may be omitted.

The embodiment will be described in the following order.

1. Functional structure

1-1. Functional structure of the storage use system

1-2. Functional structure of the removal storage device

1-3. Functional structure of the information processing apparatus

2. Hardware structure of the information processing apparatus
3. System operation

3-1. First operation example

3-2. Second operation example

4. Examples of effects

### 1. FUNCTIONAL STRUCTURE

### 1-1. Functional Structure of a Storage Use System

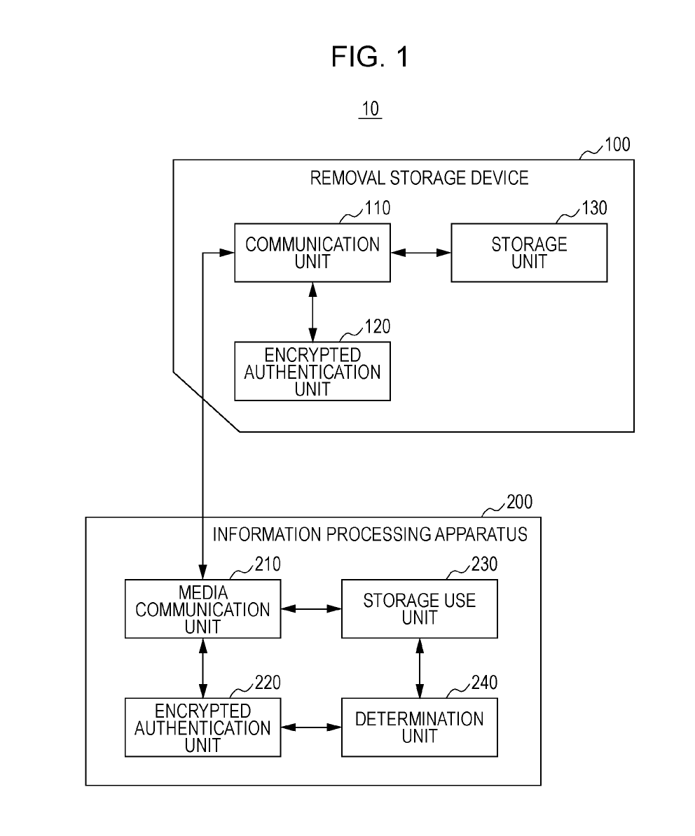

First, a storage use system 10 including a removal storage device 100 and an information processing apparatus 200 according to an embodiment of the present disclosure will be described with reference to FIG. 1. FIG. 1 is a functional block diagram showing the storage use system 10 according to the embodiment of the present disclosure.

The removal storage device 100 is a portable storage device such as a memory stick. The removal storage device 100 is also connected to the information processing apparatus 200 to store digital data stored in the information processing apparatus 200. The removal storage device 100 also makes digital data stored in the removal storage device 100 available to the information processing apparatus 200 in response to a digital data read request from the connected information processing apparatus 200.

The information processing apparatus 200 is a host device that has the function of connecting to the removal storage device 100. The information processing apparatus 200 may be an information processing apparatus such as a personal computer (PC), consumer video image processing apparatus (such as DVD recorder or video cartridge recorder), personal digital assistant (PDA), consumer game machine, electrical household appliance, etc. The information processing apparatus 200 also may be an information processing apparatus such as a mobile phone, personal handy-phone system (PHS), portable music player, portable video image processing apparatus, portable game machine, etc.

### 1-2. Functional Structure of the Removal Storage Device

First, the removal storage device 100 mainly includes a communication unit 110, an encrypted authentication unit 120, and a storage unit 130.

The communication unit 110 is a functional unit that is connected to the information processing apparatus 200 located externally to exchange signals. The communication unit 110 may include a connection terminal used to connect to the information processing apparatus 200, a signal processing unit that processes signals transmitted or received via the connection terminal, etc. When the removal storage device 100 is a medium that transmits or receives data through non-contact communication, the communication unit 110 may include an antenna.

The encrypted authentication unit 120 has the function of establishing an encrypted communication path with the information processing apparatus 200 to perform various types of encryption authentication processing. Encrypted authentication processing has the function of confirming that the apparatus to authenticate has a particular private authentication key embedded, for example. The encrypted authentication unit 120 uses this function to confirm that the apparatus to authenticate is an authentic product that supports encrypted authentication processing. Encrypted authentication processing achieves the session property, integrity, and concealment by establishing the bus key and session key and using the encrypted communication path. In addition, encrypted authentication processing provides the function of reading the unique identifier of a connected product and reading and writing accounting information and information about copy protection use conditions while ensuring the session property and integrity. Encrypted authentication processing also provides the function of reading or writing copy-protected contents while ensuring the concealment.

The encrypted authentication unit 120 can execute the encrypted authentication processing by using, for example, the public key encryption technology. The encrypted authentication unit 120 encrypts a random number passed from the information processing apparatus 200 using the private key held by the encrypted authentication unit 120. The value encrypted here can be decrypted to the original random number using the public key held by the information processing apparatus 200. Accordingly, the information processing apparatus 200 can confirm that the partner holding the private key has executed encryption operation.

In addition, the encrypted authentication unit 120 can execute the encrypted authentication processing above by using the shared private key encryption technology. The encrypted authentication unit 120 encrypts a random number passed from the information processing apparatus 200 using a shared private key. When the encrypted value matches the result of processing by a shared private key held by the information processing apparatus 200, they are found to be a set of products that have the same shared private key.

The encrypted authentication unit 120 according to the embodiment encrypts the estimated total capacity of the storage unit 130 and transmits the result to the information processing apparatus 200. The estimated total capacity may be a precise total capacity represented, for example, on a byte-per-byte basis. The estimated total capacity may also be represented by an approximate total capacity and the range of error. In this case, the estimated total capacity may be represented as “approximately 2 GB with an error of ±10%”. The estimated total capacity may also be represented according to a predetermined rule. An example of the predetermined rule is that “equal to or less than 31st power of 2 bytes” is represented as Number “31”.

The storage unit 130 has the function of storing data. The storage unit 130 may be a non-volatile memory such as a flash memory, electronically erasable and programmable read only memory (EEPROM), magnetoresistive random access memory (MRAM), ferroelectric random access memory (FeRAM), or phase change random access memory (PRAM), or a magnetic recording medium such as a hard disk drive (HDD).

### 1-3. Functional Structure of the Information Processing Apparatus

The information processing apparatus 200 mainly includes a media communication unit 210, an encrypted authentication unit 220, a storage use unit 230, and a determination unit 240.

The media communication unit 210 is a functional unit that connects to the removal storage device 100 located externally to exchange signals. The media communication unit 210 may include, for example, a connection terminal used to connect to the removal storage device 100, a signal processing unit that processes a signal transmitted or received via the connection terminal, etc. When the removal storage device 100 is a medium that transmits or receives data through non-contact communication, the media communication unit 210 may include an antenna.

The encrypted authentication unit 220 has the function of establishing an encrypted communication path with the removal storage device 100 to perform various types of encryption authentication processing. Encrypted authentication processing has the function of, for example, confirming that the authentication partner has a particular private authentication key embedded. The encrypted authentication unit 220 uses this function to confirm that the authentication partner is an authentic product that supports encrypted authentication processing. Encrypted authentication processing achieves the session property, integrity, and concealment by establishing the bus key and session key and using the encrypted communication path. In addition, encrypted authentication processing provides the function of reading the unique identifier of a connected product and reading or writing accounting information and information about copy protection use conditions while ensuring the session property and integrity. Encrypted authentication processing also provides the function of reading or writing copy-protected contents while ensuring the concealment.

The encrypted authentication unit 220 according to the embodiment has the function of obtaining the estimated total capacity from the removal storage device 100 through the encrypted communication path. The encrypted authentication unit 220 inputs the obtained estimated total capacity to the determination unit 240.

The storage use unit 230 has the function of using the removal storage device 100 connected through the media communication unit 210. More specifically, the storage use unit 230 has the function of writing data to the removal storage device 100 and the function of reading data from the removal storage device 100. The storage use unit 230 can obtain the total capacity of the storage unit 130 of the removal storage device 100 to be used. Then, the storage use unit 230 inputs the obtained total capacity to the determination unit 240. The storage use unit 230 controls operation related to the use of storage according to the result of determination by the determination unit 240 described later.

The determination unit 240 has the function of determining whether the difference between the estimated total capacity input by the encrypted authentication unit 220 and the total capacity input by the storage use unit 230 falls within a predetermined range by comparing the estimated total capacity with the total capacity. The predetermined range used here is desirably a range that allows the difference between the estimated total capacity and the total capacity to be determined as the range of error. When the difference between the estimated total capacity and the total capacity exceeds the predetermined range, the determination unit 240 can restrict the use of the storage unit 130 by the storage use unit 230. For example, a specific example of restriction that can be imposed here is to disable the recognition of the storage being used by the storage use unit 230. When the difference between the estimated total capacity and the total capacity exceeds the predetermined range, the storage medium being used by the storage use unit 230 is probably different from the storage medium of the removal storage device used for encrypted authentication. Accordingly, the use of this storage medium is desirably restricted.

Examples of the functions of the removal storage device 100 and the information processing apparatus 200 according to the present embodiment have been shown above. The above components may include general members or circuits or include hardware specific to the functions of the components. Also, the functions of the components may be implemented by a CPU or other calculation device by reading, interpreting, and executing a control program describing the procedure for achieving the functions stored in a read only memory (ROM) or random access memory (RAM). That is, the structure to be used can be changed depending on the level of a technique for carrying out the present embodiment.

It is possible to create a computer program for achieving the functions of the removal storage device 100 and the information processing apparatus 200 according to the present embodiment and to incorporate the program in a personal computer etc. It is also possible to provide a computer-readable recording medium that stores the computer program of this type. The recording medium is, for example, a magnetic disc, optical disc, magneto-optical disc, flash memory, etc. In addition, the above computer program may be delivered through, for example, a network without being stored in the recording medium.

### 2. HARDWARE STRUCTURE OF THE INFORMATION PROCESSING APPARATUS

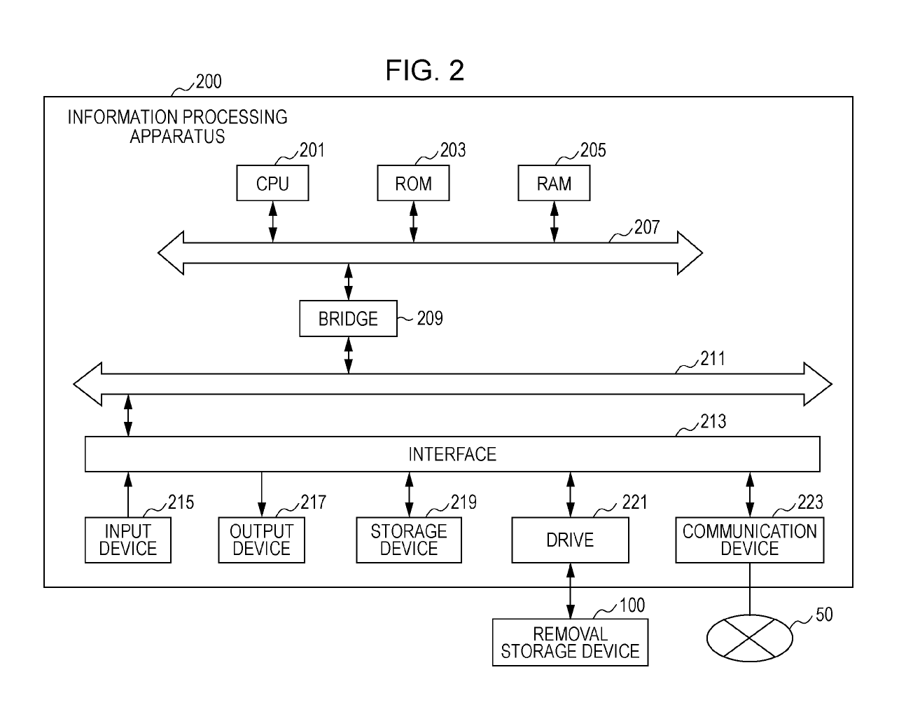

Next, an example of the hardware structure of the information processing apparatus 200 for achieving the functions described above will be described with reference to FIG. 2. FIG. 2 shows the hardware structure of the information processing apparatus 200 according to the embodiment.

The information processing apparatus 200 includes a central processing unit (CPU) 201, a read only memory (ROM) 203, a random access memory (RAM) 205, a host bus 207, a bridge 209, an external bus 211, an interface 213, an input device 215, an output device 217, a storage device 219, a drive 221, and a communication device 223.

The CPU 201 operates as a computing unit and control unit and controls the entire operation of the information processing apparatus 200 according to various programs. The CPU 201 may be a microprocessor. The ROM 203 stores programs or computation parameters used by the CPU 201. The RAM 205 is a primary storage that stores programs used during operation of the CPU 201 and parameters that change as appropriate during operation of the CPU 201. These components are interconnected through the host bus 207, which includes a CPU bus.

The host bus 207 is connected to an external bus 211 such as the peripheral component interconnect/interface (PCI) bus through the bridge 209. The host bus 207, the bridge 209, and the external bus 211 are not necessarily configured separately and these functions may be implemented as one bus.

The input device 215 includes input units, an input control circuit, etc. The input units are used by the user to input information, such as a mouse, keyboard, touch panel, button, microphone, switch, and lever. The input control circuit generates an input signal based on user input and outputs the signal to the CPU 201. The user of the information processing apparatus 200 can operate the input device 215 to input an instruction for storing various types of data in the removal storage device 100 or for reading various types of data from the removal storage device 100.

The output device 217 includes a display unit such as a cathode ray tube (CRT) display unit, liquid crystal display (LCD) unit, organic light emitting diode (OLED) unit, and lamp and a sound output unit such as a speaker and headphone. The output device 217 outputs, for example, replayed contents. More specifically, the display unit displays replayed video data and other various types of information as text or images. On the other hand, the sound output unit converts the replayed sound data etc. into sound and outputs it.

The storage device 219 is a data storage device configured as an example of the storage unit of the information processing apparatus 200 according to the present embodiment and includes a recording medium, a recording apparatus that records data in the recording medium, a reading apparatus that reads data from the recording medium, a deleting unit that deletes data recorded in the recording medium, etc. The storage device 219 can store programs executed by the CPU 201 and various types of data.

The storage device 219 includes, but not limited to, a magnetic recording medium such as a hard disk drive (HDD) or a non-volatile memory such an electronically erasable and programmable read only memory (EEPROM), flash memory, magnetoresistive random access memory (MRAM), ferroelectric random access memory (FeRAM), or phase change random access memory (PRAM) as a storage medium.

The drive 221 is a storage medium reader/writer and disposed internal or external to the information processing apparatus 200. The drive 221 reads information recorded in the removal storage medium 100 installed, such as a magnetic disc, optical disc, magneto-optical disc, or semiconductor memory and outputs it to the RAM 103.

The communication device 223 is, for example, a communication interface including a communication device etc. used to connect to a communication network 50. The communication device 223 may be a wireless LAN (local area network) communication device, wireless USB communication device, or wired communication device, which performs wired communication.

### 3. SYSTEM OPERATION

### 3-1. First Operation Example

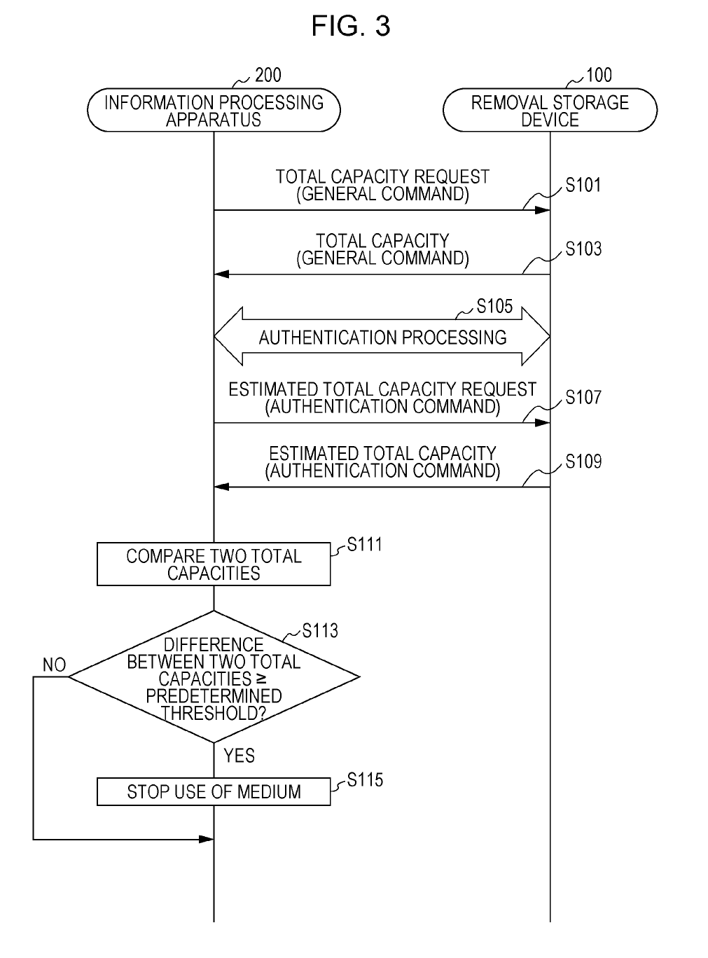

Next, an operation example of the storage use system 10 will be described with reference to FIG. 3. FIG. 3 is a sequence diagram showing a first operation example of the storage use system 10 according to the embodiment.

First, the information processing apparatus 200 requests the storage medium to be used as a storage area to send the total capacity by using a general command (S101). The removal storage device 100 provides the total capacity in response to this request (S103). It is assumed that the information processing apparatus 200 sends a dedicated command to the removal storage device 100 to check the total capacity. However, the present disclosure is not limited to this example. For example, the total capacity may be obtained by the storage use unit 230 of the information processing apparatus 200 by reading the media capacity described. Alternatively, the total capacity may be obtained by calculation based on interpretation according to the specification format of the partition or file system.

Authentication processing is performed between the encrypted authentication unit 220 of the information processing apparatus 200 and the encrypted authentication unit 120 of the removal storage device 100 (S105). In this authentication processing, the authentication partners mutually confirm that they supports the same encrypted authentication. Then, the information processing apparatus 200 requests the removal storage device 100 to send the estimated total capacity through the encrypted communication path by using an authentication command (S107). The removal storage device 100 provides the estimated total capacity for the information processing apparatus 200 (S109).

In the information processing apparatus 200, the determination unit 240 compares the two obtained total capacities (S111). That is, the determination unit 240 compares the estimated total capacity obtained from the partner unit of encrypted authentication with the total capacity obtained from the storage medium on which data is read or written. The determination unit 240 determines whether the difference between the two total capacities is equal to or more than a predetermined threshold (S113). When the difference between the estimated total capacity obtained from the partner unit of encrypted authentication and the total capacity obtained from the storage medium on which data is read or written is equal to or more than the predetermined threshold, the determination unit 240 lets the storage use unit 230 stop the use of the removal storage device 100 (S115).

The stopping the use of removal storage device 100 described in step S115 above is an example of “restriction on the use of the storage medium by the storage use unit 230” imposed by the determination unit. The present disclosure is not limited to this example and can be implemented as a second operation example described below, for example.

### 3-2. Second Operation Example

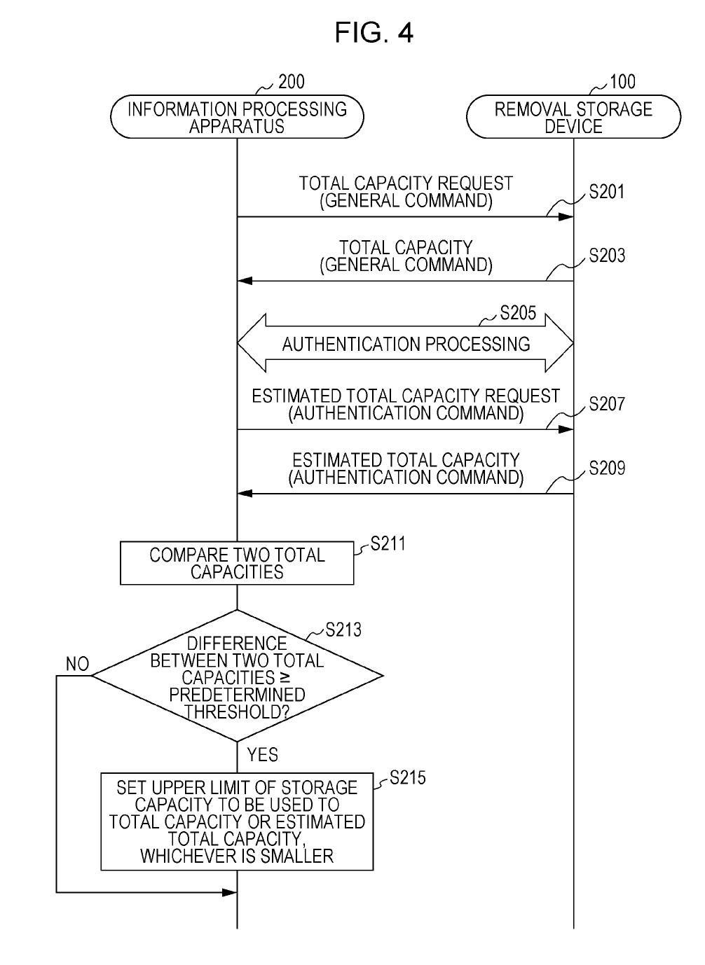

Next, an operation example of the storage use system 10 will be described below with reference to FIG. 4. FIG. 4 is a sequence diagram showing the second operation example of the storage use system 10 according to the embodiment of the present disclosure.

The operation shown in steps S201 to S213 in FIG. 4 is the same as that shown in FIG. 3, so the description will be omitted here. The second operation example is difference from the first operation example in “restriction on the use of the storage medium by the storage use unit 230” imposed by the determination unit in step S215. In the second operation example, the upper limit of storage capacity for writing data used by the storage use unit 230 is set to the estimated total capacity obtained from the partner unit of encrypted authentication or the total capacity obtained from the storage medium on which data is read or written, whichever is smaller (S215).

In the first operation example, the estimated total capacity obtained from the partner unit of encrypted authentication and the total capacity obtained from the storage medium on which data is read or written are both obtained from the removal storage device 100. Accordingly, the estimated total capacity and the total capacity are approximately the same and the restriction on the use of the storage medium by the storage use unit 230 is not imposed. Next, the usage pattern in which the restriction on the use of the storage medium by the storage use unit 230 is imposed will be described together with effects of the structure of the embodiment.

### 4. EXAMPLE OF EFFECTS

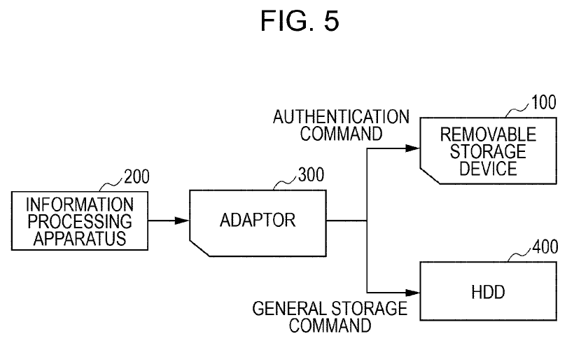

Next, effects of the structure of the storage use system 10 according to the embodiment will be described with reference to FIG. 5. FIG. 5 describes effects of the structure of the storage use system 10 according to the embodiment.

FIG. 5 shows an adaptor 300 that has interfaces connected to both the removal storage device 100 and the information processing apparatus 200 and is connected to a storage device (for example, a hard disk drive, here) 400, which is different from the removal storage device 100.

The structure of the information processing apparatus 200 described in the storage use system 10 according to the embodiment prevents the use of the adaptor 300 shown in FIG. 5. The adaptor 300 inputs an authentication command received from the information processing apparatus 200 to a removal storage device 100, which supports the authentication function. The adaptor 300 also inputs a general storage command received from the information processing apparatus 200 to the hard disk drive 400. That is, the adaptor 300 divides communication among the removal storage device 100, which supports authentication, and the hard disk drive 400, which does not support authentication, depending on the type of a command received. The adaptor 300 provided by an organization that is not familiar with encrypted authentication made between the removal storage device 100 and the information processing apparatus 200 may interfere with normal operation.

The removal storage device 100 and the information processing apparatus 200 according to the embodiment compare the estimated total capacity obtained from the partner unit of encrypted authentication with the total capacity obtained from the storage medium on which data is read or written and impose restriction on the read/write operation for the storage medium, depending on the comparison result. When this processing is performed in the structure shown in FIG. 5, the estimated total capacity is obtained from the removal storage device 100 and the total capacity is obtained from the hard disk drive 400. Accordingly, when the difference between the total capacity of the storage medium included in the removal storage device 100 and the total capacity of the hard disk drive 400 is equal to or more than a predetermined threshold, writing of data to the hard disk drive 400 can be restricted.

The preferred embodiment of the present disclosure has been described in detail above with reference to the drawings, but the present disclosure is not limited to this example. It is clear that those skilled in the art can reach various modifications without departing from the scope of the disclosure and these modifications fall within the technical scope of the present disclosure.

For example, the removal storage device is assumed to be a memory stick in the above embodiment, but the present disclosure is not limited to this example. For example, the structure of the present disclosure may be applied to any device that uses encrypted authentication and has a storage area, such as a USB (universal serial bus) memory or non-contact IC (integrated circuit) card.

Steps shown in the sequence diagrams in this specification may be executed chronologically in the order described or may be executed in parallel or individually, that is, non-chronologically. Steps to be executed chronologically may be sometimes executed non-chronologically.

The present disclosure contains subject matter related to that disclosed in Japanese Priority Patent Application JP 2010-268607 filed in the Japan Patent Office on Dec. 1, 2010, the entire contents of which are hereby incorporated by reference.

What is claimed is:

1. An information processing apparatus comprising:
an encrypted authentication unit that obtains, as encrypted information, an estimated total capacity of a storage medium included in a removable storage device, the removable storage device being a target of encrypted authentication;
a storage use unit that obtains a total capacity of a storage medium to which data is written; and
a determination unit that restricts the use by the storage use unit of the storage medium to which the data is written depending on whether a difference between the estimated total capacity and the total capacity is equal to or more than a predetermined threshold.

2. The information processing apparatus of claim 1, wherein, when the determination unit determines that the difference is equal to or more than the predetermined threshold, the storage use unit operates using the estimated total capacity or the total capacity, whichever is smaller, as the capacity of the storage medium.

3. The information processing apparatus of claim 1, wherein, when the determination unit determines that the difference is equal to or more than the predetermined threshold, the storage use unit does not read or write data on the storage device.

4. A removal storage device comprising:
a storage unit that stores data; and
an encrypted authentication unit that performs encrypted authentication with an information processing apparatus connected through an encrypted communication path and encrypts an estimated total capacity of the storage unit to provide the encrypted estimated total capacity for the information processing apparatus.

5. An information processing method comprising:
performing encrypted authentication with a removal storage device connected through an encrypted communication path;
obtaining an estimated total capacity of a storage area of the removal storage device as encrypted information;
obtaining a total capacity of an external storage medium to which data is written;
determining whether a difference between the estimated total capacity and the total capacity is equal to or more than a predetermined threshold; and
restricting reading or writing of data on the storage medium depending on whether the difference between the estimated total capacity and the total capacity is equal to or more than the predetermined threshold.

6. An information processing system comprising:
a removal storage device including
a storage unit that stores data and
a first encrypted authentication unit that encrypts and provides an estimated total capacity of the storage unit; and
an information processing apparatus including
a second encrypted authentication unit that obtains the estimated total capacity,
a storage use unit that obtains a total capacity of the storage unit, and
a determination unit that restricts the use by the storage use unit of the storage unit depending on whether a difference between the estimated total capacity and the total capacity is equal to or more than a predetermined threshold.
